(19) United States
(12) Patent Application Publication
(10) Pub. No.: US 2017/0229717 A1
(43) Pub. Date: Aug. 10, 2017

(54) ROBUST FUEL CELL STACK SEALING DESIGNS USING THIN ELASTOMERIC SEALS

(71) Applicant: GM Global Technology Operations LLC, Detroit, MI (US)

(72) Inventors: Anita Luong, Ann Arbor, MI (US); Yeh-Hung Lai, Oakland, MI (US)

(21) Appl. No.: 15/019,128

(22) Filed: Feb. 9, 2016

(51) Int. Cl. H01M 8/0276; H01M 8/1004; H01M 8/0284; H01M 8/1007; H01M 8/2404; H01M 8/242; H01M 8/2475; H01M 8/2457; H01M 8/0247; H01M 8/0286

(52) U.S. Cl. CPC H01M 8/0278; H01M 8/0247; H01M 8/1004; H01M 8/0284; H01M 8/0286; H01M 8/2404; H01M 8/242; H01M 8/2475; H01M 8/2457; H01M 8/1007; H01M 2250/20

(57) ABSTRACT

A sealing assembly for a fuel cell system and a method of assembling a fuel cell system. The system is made up of numerous fluid-conveying plate assemblies stacked such that seals are placed between adjacent plates. Microseals are disposed on one or both of metal beads and subgaskets such that when fuel cells comprising such metal beads, microseals and gaskets are aligned and compressed into a housing of a fuel cell stack, the leakage impacts of any misalignment in the cells is reduced. In particular, variations in microseal design including geometric and material properties such as microseal aspect ratio, Poisson's Ratio and as-deposited shape may be tailored to provide optimum sealing between facing metal beads and subgaskets.

### BACKGROUND OF THE INVENTION

The present invention relates generally to an apparatus and method for improved reactant and coolant flow sealing within joined or fluidly-cooperating fluid-delivery plates used in a fuel cell assembly, and more particularly to the use of a microseal disposed on top of a metal bead that is integrally formed on a cooperating surface of one or both of the plates to provide more effective fluid isolation for the reactant or coolant that is conveyed through channels defined within the plate surfaces.

Fuel cells convert a fuel into usable energy via electrochemical reaction. A significant benefit to such an approach is that it is achieved without reliance upon combustion as an intermediate step. As such, fuel cells have several environmental advantages over internal combustion engines (ICEs) for propulsion and related motive applications. In a typical fuel cell —such as a proton exchange membrane or polymer electrolyte membrane (in either event, PEM) fuel cell—a pair of catalyzed electrodes are separated by an ion-transmissive medium (such as Nafion™) in what is commonly referred to as a membrane electrode assembly (MEA). The electrochemical reaction occurs when a first reactant in the form of a gaseous reducing agent (such as hydrogen, H₂) is introduced to and ionized at the anode and then made to pass through the ion-transmissive medium such that it combines with a second reactant in the form of a gaseous oxidizing agent (such as oxygen, O₂) that has been introduced through the other electrode (the cathode); this combination of reactants form water as a byproduct. The electrons that were liberated in the ionization of the first reactant proceed in the form of direct current (DC) to the cathode via external circuit that typically includes a load (such as an electric motor, as well as various pumps, valves, compressors or other fluid delivery components) where useful work may be performed. The power generation produced by this flow of DC electricity can be increased by combining numerous such cells into a larger current-producing assembly. In one such construction, the fuel cells are connected along a common stacking dimension in the assembly—much like a deck of cards—to form a fuel cell stack.

In such a stack, adjacent MEAs are separated from one another by a series of reactant flow channels, typically in the form of a gas impermeable, electrically conductive bipolar plates (also referred to herein as flow field plates). In one common form, the channels are of a generally serpentine layout, although other forms—including those with generally straight or sinusoidal patterns—may also be used. Regardless of the channel shape, it covers the majority of the generally planar surfaces of each plate. The juxtaposition of the plate and MEA promotes the conveyance of one of the reactants to or from the fuel cell, while additional channels (that are fluidly decoupled from the reactant channels) may also be used for coolant delivery. In one configuration, the bipolar plate is itself an assembly formed by securing a pair of thin metal sheets (called half plates, or more simply, plates) that have the channels stamped or otherwise integrally formed on their surfaces, while in another, the assembly includes an additional interstitial sheet with channels to put coolant into thermal communication with the adjacent anode and cathode channels of the outer sheets. Regardless of whether the assembly is two-sheet or three-sheet variety, the various reactant and coolant flowpaths formed by the channels on each of these sheets typically convene at a manifold (also referred to herein as a manifold region or manifold area) defined on one or more opposing edges of the plate. Examples of all of these features—as well as a typical construction of such bipolar plate assemblies that may be used in PEM fuel cells—are shown and described in commonly-owned U.S. Pat. Nos. 5,776,624 and 8,679,697, the contents of which are hereby incorporated by reference.

It is important to avoid leakage and related fluid crosstalk within a PEM fuel cell stack. This is of particular concern in the manifold regions of the bipolar plates where by virtue of higher pressures relative to the plate active regions, there is a greater tendency of fluids therein to be forced out through holes, surface undulations and related sealing discontinuities. To mitigate against leakage of such high pressure fluids, the Assignee of the present invention has used separate thick elastomeric seals placed between at least these regions of adjacently-stacked bipolar plates. In one form, the seals were overlaid on the surface to define a generally picture-frame type of structure as a way to circumscribe the region of the plate as a way to form a cooperative interface with an adjacent plate or other component. In other configurations, the Assignee of the present invention has formed grooves into the plate surface such that generally cylindrical or string-shaped seals placed within the grooves can providing the sealing interface. Regardless of whether the seals are configured to cooperate with grooved or non-grooved surfaces, even slight misalignment between adjacent plates under compression (such as that attendant to stack assembly) leads to variations in pressure applied to the corresponding seals, which in turn leads to seal deformation and concomitant gap formation and reactant or coolant leakage. Moreover, the use of separately-formed thick seal assemblies—while generally helpful in achieving improved sealing—is incompatible with commercial automotive fuel cell assembly applications, where high volume manufacturing requirements may involve the production of large numbers of fuel cell stacks per year. Given that each cell requires a bipolar plate assembly on both opposing surfaces of the MEA, even low volume production would require that a significant number of plates be made. As such, these thick sealing approaches would be a cost-prohibitive way to achieve the sealing methods needed to reduce reactant or coolant channel flow losses.

To overcome some of the cost and manufacturing issues related to the use of thick elastomeric sealing approaches, the Assignee of the present invention has developed integrally-formed bipolar plate sealing where the plate surfaces are stamped in a manner similar to that which is used to form the reactant or coolant channels. This stamping produces outward-projecting metal beads to establish generally planar plateaus that define discrete contact points between adjacent plate surfaces. While such a configuration is more compatible with the high-volume production needs mentioned above, proper sealing remains difficult to achieve, especially in view of the inherent vagaries of fuel cell stack manufacturing where both dimensional tolerances of the components as well as the cell-to-cell alignment of one hundred or more individual cells within the stack are likely to be present.

It would be desirable to provide enhanced sealing between adjacently-stacked plates (whether within a single bipolar plate assembly or across numerous plates within a fuel cell stack), including ensuring that such seals are impervious to the effects of component tolerances, interplate misalignment and other hard-to-control manufacturing factors. It would likewise be desirable to achieve such sealing in a repeatable, cost-effective manner.

### SUMMARY OF THE INVENTION

It is an object of the disclosure to provide a microseal that will help make the process of joining bipolar plates and their metal beads relatively impervious to the plate-to-plate misalignment and component tolerances. According to a first aspect of the present invention, a bipolar plate assembly for a fuel cell system includes a pair of plates (often referred to as half-plates) that are joined together such that a microseal disposed on the metal bead surfaces of at least one of the half-plates increases the fluid-tight seal between them. A subgasket is placed between the pair of plates and can cooperate with the microseal and an MEA that is disposed between the pair of plates. In addition, the subgasket is sized and shaped from a non-conductive and gas impermeable material such that it forms a frame-like periphery around the MEA as a way to separate and prevent contact between the electronically conductive layers (electrodes and gas diffusion layer) on the cell's anode and cathode sides. By the cooperation of the microseal and the engaging surface of the respective metal bead and subgasket, fluid isolation between the pair of plates is maintained, while the cooperation of the subgasket and the MEA ensures the desired electrical isolation.

In the present context, one or both of the half-plates will be understood to be made from a thin underlying metal structure that includes planar opposing surfaces at least one of which defines one or more of a reactant channel, reactant manifold, coolant channel and coolant manifold. Likewise, the metal bead is defined by a rectangular, trapezoidal, hemispherical or related shape cross section that is integrally-formed with and projects out of the surface of the half-plates; this metal bead provides the necessary seal force and related fluid isolation between cooperatively engaged plates via suitable balance of out-of-plane elasticity and stiffness. Furthermore, the microseal is a layer of polymeric material (such as that discussed in more detail below) that may be deposited via various methods (also discussed in more detail below) onto the metal bead or subgasket. Together, the microseal and the underlying metal bead make up a metal bead seal (MBS), where the functions of the microseal are to (a) fill in the imperfection of the metal bead and subgasket surfaces, (b) induce more uniform seal force per length along the MBS length by providing a compliant cushion to make up the non-uniform compressed height of the metal bead, (c) prevent the gas/fluid permeation through the bulk of the microseal and (d) to prevent leakage at the subgasket/microseal or metal bead/microseal interfaces. Moreover in the present context, the peripheral formation of the subgasket does not require complete edgewise coverage around the MEA, but rather complete through-the-thickness electrical isolation between the MEA's anode and cathode.

According to another aspect of the present invention, a method of assembling a fuel cell system includes placing numerous fuel cells on top of one another in a stacked configuration and placing a microseal on top of a metal bead that is integrally formed as part of at least one plate of a bipolar plate assembly. The plate, metal bead and microseal configuration are similar to those discussed in the previous aspect.

These and other objects, features, embodiments, and advantages will become apparent to those of ordinary skill in the art from a reading of the following detailed description and the appended claims.

### BRIEF DESCRIPTION OF THE DRAWINGS

The following detailed description of the preferred embodiments of the present invention can be best understood when read in conjunction with the following drawings, where like structure is indicated with like reference numerals and in which the various components of the drawings are not necessarily illustrated to scale:

FIG. 1 depicts a simplified exploded view of a fuel cell stack that can be assembled according to an aspect of the present invention;

FIG. 2 is a simplified illustration of a partially exploded, sectional view of a single fuel cell from the stack of FIG. 1 where the cell includes portions of upper and lower surrounding bipolar plates;

FIG. 3 is an exploded perspective detailed view of a bipolar plate assembly from that includes channels, seals and various areas formed on a surface thereof;

FIG. 4A shows a simplified cross-sectional view indicating the placement of a metal bead, microseal and subgasket according to a first aspect of the present invention that can be used in the bipolar plate assembly of FIG. 3;

FIG. 4B shows a simplified cross-sectional view indicating the placement of a metal bead, microseal and subgasket according to a second aspect of the present invention that can be used in the bipolar plate assembly of FIG. 3;

FIG. 5 shows the sensitivity of MBS stiffness to misalignment based on differences in Poisson's Ratio of the microseal;

FIG. 6 shows how a gap may form between a metal bead and a subgasket; and

FIG. 7 shows a notional shape of an as-printed microseal, where a slightly domed-shaped upper surface is formed.

### DETAILED DESCRIPTION OF THE EMBODIMENTS

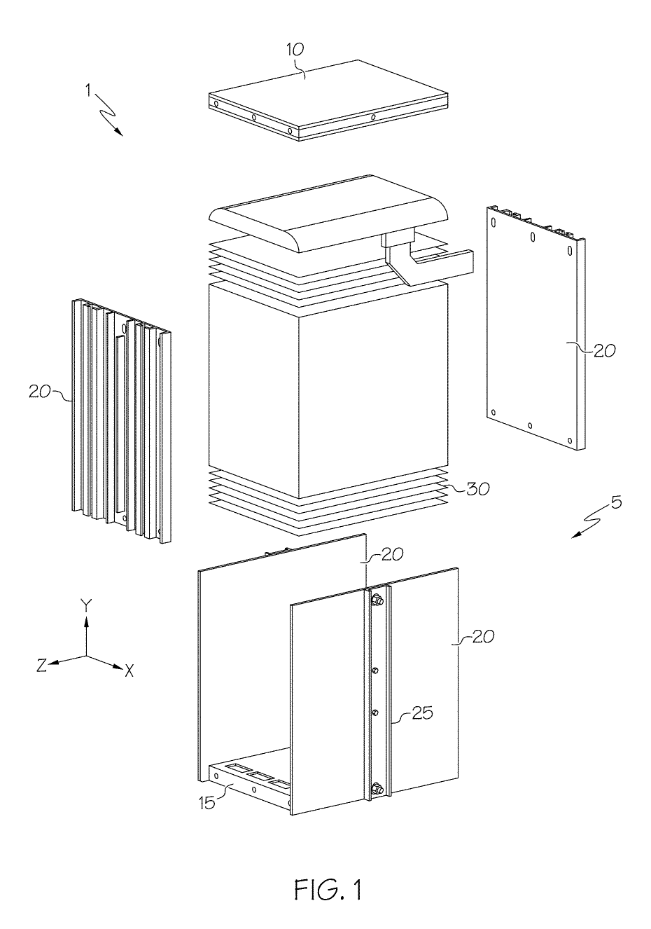

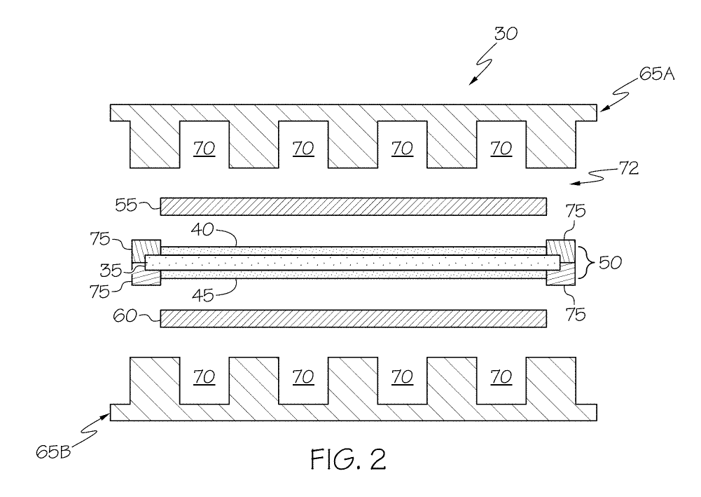

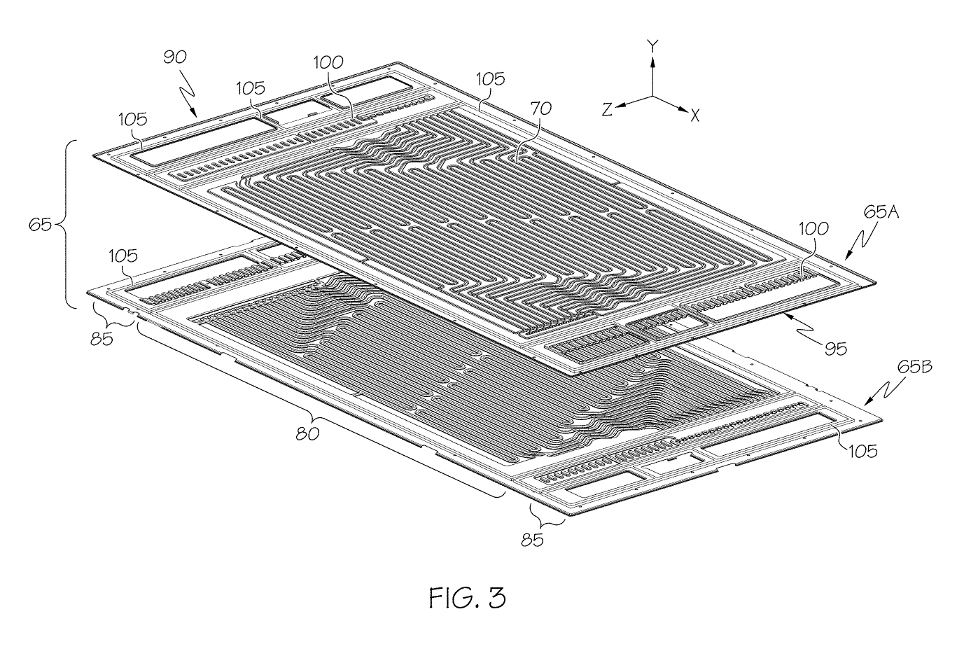

Referring initially to FIGS. 1 through 3, a simplified view of fuel cell stack in exploded form (FIG. 1), a PEM fuel cell (FIG. 2) and a bipolar plate assembly (FIG. 3) are shown. The stack 1 includes a housing 5 made up of a dry end unit plate 10 and a wet end unit plate 15; these (as well as others, not shown) may help perform the compressive clamping action of the compression retention system of the housing 5; such compression retention system includes numerous bolts (not shown) that extend through the thickness of the stack 1, as well as various side panels 20 and rigid bracketing elements 25 disposed vertically along the stacking direction (the Y axis) for securing the wet end unit plate 15 to the dry end unit plate 10. Stacks of numerous fuel cells 30 are securely held in a compressive relationship along the stacking direction by the action of the bolts, bracketing elements 25 and other components within housing 5. Thus, in the present context, the stacking axis of the fuel cell 1 may be along a substantially vertical (i.e., Y) Cartesean axis so that the majority of the surface of each of the fuel cells 30 is in the X-Z plane. Regardless, it will be appreciated by those skilled in the art that the particular orientation of the cells 30 within stack 1 isn't critical, but rather provides a convenient way to visualize the landscape that is formed on the surfaces of the individual plates that are discussed in more detail below.

The fuel cell 30 includes a substantially planar proton exchange membrane 35, anode catalyst layer 40 in facing contact with one face of the proton exchange membrane 35, and cathode catalyst layer 45 in facing contact with the other face. Collectively, the proton exchange membrane 35 and catalyst layers 40 and 45 are referred to as the MEA 50. An anode diffusion layer 55 is arranged in facing contact with the anode catalyst layer 40, while a cathode diffusion layer 60 is arranged in facing contact with the cathode catalyst layer 45. Each of diffusion layers 55 and 60 are made with a generally porous construction to facilitate the passage of gaseous reactants to the catalyst layers 40 and 45. Collectively, anode catalyst layer 40 and cathode catalyst layer 45 are referred to as electrodes, and can be formed as separate distinct layers as shown, or in the alternate (as mentioned above), as embedded at least partially in diffusion layers 55 or 60 respectively, as well as embedded partially in opposite faces of the proton exchange membrane 35. In fact, as will be appreciated by those skilled in the art, the precise placement of the catalyst layers 40, 45 on the membrane 35 or diffusion layers 55, 60 is not critical to the operation of the embodiments of the invention discussed herein; as such, MEAs 50 may be in one of two conventional forms the first of which is a catalyst coated membrane (CCM), and the second of which is catalyst coated diffusion media (CCDM) that is subsequently attached to the PEM. Either variant is deemed to be compatible with and therefore within the scope of the present invention.

In addition to providing a substantially porous flowpath for reactant gases to reach the appropriate side of the proton exchange membrane 35, the diffusion layers 55 and 60 provide electrical contact between the electrode catalyst layers 40, 45 and an assembly of bipolar plates 65 that in turn acts as a current collector. Although shown notionally as having a thick-walled structure in FIG. 2, the individual plates 65A and 65B (also referred to herein as half-plates) that make up the assembly preferably employ thin sheet-like or foil-like structure (as will be shown and described in more detail below in conjunction with FIG. 3); as such, FIG. 2 should not be used to infer the relative bipolar plate 65 thickness. Simplified opposing surfaces defined by the facingly-adjacent half-plates 65A and 65B are provided to separate each MEA 50 and accompanying diffusion layers 55, 60 from adjacent MEAs and layers (neither of which are shown) in the stack 1. One half-plate 65A engages the anode diffusion layer 55 while a second half-plate 65B engages the cathode diffusion layer 60. The two thin, facing metal sheets that make up the half-plates 65A, 65B define—upon suitable compression and related joining techniques—an assembled plate 65. Each half-plate 65A and 65B defines numerous reactant gas flow channels 70 along a respective plate face. Although bipolar plate 65 is shown (for stylized purposes) defining purely rectangular reactant gas flow channels 70 and surrounding structure, it will be appreciated by those skilled in the art that a more accurate (and preferable) embodiment will be shown below, where generally serpentine-shaped channels 70 formed out of the stamped, generally trapezoidal cross-sectional profiles are defined.

Subgaskets 75 may be used to promote seal attachment or related cooperation between the half-plates 65A and 65B and the MEA 50; in one form, subgasket 75 may be made from a plastic material to define an electrically non-conductive picture frame-like profile that may be placed peripherally to protect the edge of the MEA 50. This subgasket 75—which is preferably between about 50 μm and 250 μm in thickness—is often used to extend the separation of gases and electrons between the catalyst layers 40 and 45 to the edge of MEA 50 as a way to increase the membrane 35 active surface area.

In operation, a first gaseous reactant, such as H₂, is delivered to the anode side of the MEA 50 through the channels 70 from half-plate 65A, while a second gaseous reactant, such as O₂ (typically in the form of air) is delivered to the cathode side of the MEA 50 through the channels 70 from half-plate 65B. Catalytic reactions occur at the anode 40 and the cathode 45 respectively, producing protons that migrate through the proton exchange membrane 35 and electrons that result in an electric current that may be transmitted through the diffusion layers 55 and 60 and bipolar plate 65 by virtue of contact between it and the layers 55 and 60. Related channels (not shown) may be used to convey coolant to help control temperatures produced by the fuel cell 1. In situations where the half-plates 65A, 65B are configured for the flow of coolant, their comparable features to their reactant-conveying plate counterparts are of similar construction and will not be discussed in further detail herein.

Referring with particularity to FIG. 3, an exploded view showing two adjacently-stacked half-plates 65A, 65B to form the bipolar plate 65 assembly is shown in more detail. In particular, the individual half-plates 65A, 65B each include both an active area 80 and a manifold area 85, where the former establishes a planar facing relationship with the electrochemically active area that corresponds to the MEA 50 and diffusion layers 55 and 60 and the latter corresponds an edge (as shown) or peripheral (not shown) area where apertures formed through the plates 65A, 65B may act as conduit for the delivery and removal of the reactants, coolant or byproducts to the stacked fuel cells 30. As can be seen from the exploded view of FIG. 3, these two half-plates 65A, 65B may be used to form a sandwich-like structure with the MEA 50 and anode and cathode diffusion layers 55, 60 and then repeated as often as necessary to form the fuel cell stack 1. In one form, one or both of the anode half-plate 65A and cathode half-plate 65B are made from a corrosion-resistant material (such as 304L SS or the like). The generally serpentine gas flow channels 70 form a tortuous path from near one edge 90 that is adjacent one manifold area 85 to near the opposite edge 95 that is adjacent the opposing manifold area 85. As can be seen, the reactant (in the case of a plate 65A, 65B placed in facing relationship with the MEA 50) or coolant (in the case of a plate 65A placed in facing relationship with the back of another plate 65B where coolant channels are formed) is supplied to channels 70 from a series of repeating gates or grooves that form a header 100 that lies between the active area 80 and the manifold area 85 of one (for example, supply) edge 90; a similar configuration is present on the opposite (for example, exhaust) edge 95. In an alternate embodiment (not shown), the supply and exhaust manifold areas can lie adjacent the same edge (i.e., either 90 or 95). In situations where the individual plates 65A, 65B are made from a formable material (such as the aforementioned stainless steel) the various surface features (including the grooves, channels or the like) are preferably stamped through well-known techniques, thereby ensuring that both the channels 70 and their respective structure, in addition to the MBS (which will be discussed in more detail below) are integrally formed out of a single sheet of material. Moreover, the same stamping operation that forms the lands and channels 70 in the half-plates 65A, 65B may be used to form similar shapes as discussed below.

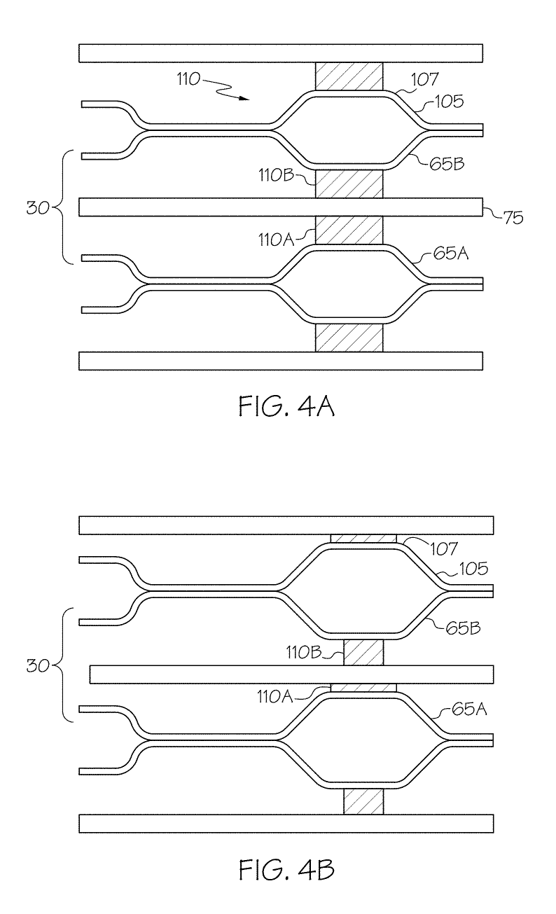

Referring next to FIGS. 4A and 4B, a cross-section view of two different embodiments according to the present invention of how the adjacently-stacked bipolar plate assembly 65 is placed in relation to other such assemblies is shown. In a preferred form, each of the half-plates 65A, 65B employ an integrally-stamped metal bead 105 that defines a gasket-like engaging surface 107 that arises out of the metal bead 105 being shaped as an upstanding rectangular, trapezoidal (as shown) or slightly curved projection. In one preferred embodiment, metal bead 105 is between about 300 μm and 600 μm in thickness, and between about 1 mm and 4 mm in width. A microseal 110 is disposed on either the engaging surface 107 or the previously-discussed subgasket 75. Together, the gasket-like structure of the engaging surface 107 of the metal bead 105 and the microseal 110 define MBS 115. As will be appreciated, the gasket-like nature of the metal bead 105 provides at least some measure of fluid isolation when joined up with another mating surface to act as a closure, while the inclusion of the thin elastomeric microseal 110 on top to result in MBS 115 provides even more fluid entrainment or isolation. The engaging surface 107 is generally similar in construction and function to the lands 72 of FIG. 2 that may also be integrally formed within one or both of the plates 65A, 65B.

Although FIG. 4A shows the metal bead 105 being formed as part of half-plate 65B, it will be appreciated that the same applies mutatis mutandis to plate 65A, and that both are deemed to be within the scope of the present invention. Regardless of whether each half-plate 65A, 65B is configured to convey reactant, coolant or both, and further regardless of whether such fluids are being conveyed through the half-plate 65A, 65B active area 80 or manifold area 85, it is important to avoid leakage of such fluids across the area boundaries, as well as across individual channel boundaries defined within each area. To this end, microseal 110 is in the form of a thin elastomeric layer is placed on the engaging surface 107 such that when multiple cells 30 are aligned, stacked and compressed into a housing 10 to make up stack 1, the microseals 110 are deformably compressed to enhance the sealing between the adjacent half-plates 65A, 65B. Although not shown in either of FIG. 4A or 4B, an MEA 50 is sandwiched between adjacent half-plates 65A, 65B such that the three components resemble cell 30. Within the present context, the thin elastomeric microseals 110 of the present invention differ from thick seals as mentioned above in a few significant ways. First, the microseals 110 are no more than about 300 μm in thickness, whereas those of conventional seals is over 1000 μm.

As mentioned above, the cooperation of the metal bead 105 and microseal 110 on each of joined half-plates 65A, 65B defines the MBS 115; this structure promotes a more robust, leakage-free sealing, regardless of whether such sealing is formed in the active area 80 or manifold area 85. In another version (not shown), the microseal 110 can be attached or directly formed onto the subgasket 75 as part or extension of the MEA 50; either variant is deemed to be within the scope of the present invention. The microseal 110 shown in this embodiment is noteworthy for its relative large aspect (i.e., thickness-to-width) ratio.

Referring with particularity to FIG. 4B, in another preferred form, the adjacently-placed microseals 110 defines an asymmetric profile, where in the present context, such a profile arises when the two adjacently-placed microseals 110 within the same bipolar plate assembly 65 define different geometric profiles. Using FIG. 4B as an example, these geometric profiles are often in the form of different aspect ratios. As shown, the topmost microseal variant 110A has a relatively tall, thick rectangular profile (i.e., high aspect ratio), while the lowermost variant 110B has a relatively short, wide rectangular profile (i.e., low aspect ratio). In one preferred form, both microseal variants 110A, 110B are either formed directly on the metal bead 105 or directly on the subgasket 75, although in another form the high aspect ratio microseal variant 110A may be formed directly on the engaging surface 107 of metal bead 105 while the low aspect ratio microseal variant 110B is formed directly on the subgasket 75. Likewise, in one preferred form where the microseal 110 is formed directly on the engaging surface 107 of metal bead 105, a known process (such as screen printing or injection molding) may be used. The Assignee of the present invention is pursuing the use of screen printing to apply the seals discussed herein in co-pending U.S. patent application Ser. No. 15/019,100 (hereinafter the '100 application) entitled SEAL MATERIAL WITH LATENT ADHESIVE PROPERTIES AND A METHOD OF SEALING FUEL CELL COMPONENTS WITH SAME the contents are incorporated herein by reference in their entirety. Additional screen printing features unique to the formation of seals are disclosed in an exemplary form in U.S. Pat. No. 4,919,969 to Walker entitled METHOD OF MANUFACTURING A SEAL, the contents of which are incorporated by reference in their entirety herein.

In a configuration where the microseal 110 is formed on the subgasket 75, the microseal 110 would need to be wider than that of the engaging surface 107 of metal bead 105. Furthermore, in a configuration where the microseal 110 is formed directly on the engaging surface 107 of metal bead 105 through screen printing, the microseal 110 defines a thickness of no greater than about 300 μm at its thickest, and an overall width of no more than about 3000 μm (i.e., 3 mm) on the engaging surface 107 of metal bead 105. More particularly, the thickness is preferably between about 30 and 300 μm, with widths of between about 1.0 and 3.0 mm.

The present inventors have observed that in traditional elastomeric seals, the sealing pressure is simply proportional to the contact pressure and width, where the proportionality constant is the material's modulus of elasticity (or tensile modulus) E. However, the present inventors have discovered that the MBS 115 of the present invention does not mimic these idealized pressure conditions, and instead needs to take spatial constraints into consideration; these constraints are due to (1) the comparatively rigid facing metal bead 105 and subgasket 75 substrates that the microseal 110 is placed on, (2) the thinness of the microseal 110 layer that is made possible by improved manufacturing process capabilities (such as the screen printing discussed herein) and (3) the assumption of substantially complete adhesion between the microseal 110 and its respective substrate as a way to enable ease of part handling during both initial manufacturing as well as during reworking or rebuilding.

Importantly, the present inventors have discovered that these constraints cause the material of the microseal 110 to exhibit a much higher stiffness (referred to herein as the effective modulus, E_{eff}) that relates the designed geometry (h′ for engaged microseal 110 height, a′ for engaged microseal 110 width and η for the aspect ratio of the microseal 110) and the material properties (including tensile modulus E and Poisson's ratio υ) to the applied loads and resulting deflections. In other words, the effective modulus or stiffness modifies the values inherent in the material makeup of the microseal 110 by taking into consideration the spatial constraints placed on the microseal 110. Even more important is that the present inventors have discovered that due to the thin geometry of the microseal 110 relative to conventional thick seals, the effective modulus E_{eff} (which better explains the leakage phenomena than recourse to a conventional nominal sealing pressure) is very sensitive to plate-to-plate and cell-to-cell misalignment. An analytical solution representing the mechanical behavior of a constrained system is presented in The Effect of Compressibility on the Stress Distributions in Thin Elastomeric Blocks and Annular Bushings by Yeh-Hung Lai, D. A. Dillard and J. S. Thornton in The Journal of Applied Mechanics (1992) the contents of which are incorporated by reference in their entirety. In equation form, this analytical representation is shown as:

$${E}_{eff} = \frac{\frac{F}{{a}^{′}}}{\frac{Δ}{{h}^{′}}} = \frac{S}{η} = \frac{6 E}{( 1 + ν ) {β}^{2} {η}^{2}} [ 1 - \frac{tanh β}{β} ]$$

where Δ represents the deflection, F represents the force (for example, in Newtons) such as that associated with compressing the cells 30 within stack 1 along their axial stacking dimension, S represents the stiffness and:

$$β = \frac{3}{η} \sqrt{\frac{2 ( 1 - 2 ν )}{1 - ν}} .$$

As such, Δ/h′ equals the strain (or change in thickness along the thickness dimension in response to the applied force F). From the above, the present inventors believe that the effective modulus E_{eff} can be related to the local sealing pressure in a manner similar to how the modulus E of the material can be related to the sealing pressure in a traditional elastomer seal design.

A key component of the present invention is to reduce the sensitivity of the microseal 110 effective modulus E_{eff} to misalignment that is directly related to the sealing pressure that the microseal 110 exerts on the facing interfaces, be it the metal bead 105 or subgasket 75. The present inventors have accounted for misalignment by considering that the engaged microseal 110 width a′ be defined as:

a′=a−α

where a equals the nominal microseal 110 width and α is the misalignment. For fuel cells of interest to the present invention, the misalignment is likely to be less than about 0.4 mm. Furthermore, in a case where there is an asymmetric microseal 110 design (such as that depicted in FIG. 4B), a total engaged thickness h′ may be described as follows:

h′=h₁+h₂

where h₁ equals the thickness of the first microseal 110A and h₂ equals the thickness of the second microseal 110B. From this, the engaged microseal 110 aspect ratio η is:

$$η = \frac{{h}_{1} + {h}_{2}}{a - α} = \frac{{h}^{′}}{{a}^{′}} .$$

Manufacturing and assembly process capabilities will determine the relevant range of the aspect ratio η. For example, assembly alignment capabilities contribute to defining a range of the misalignment α and the consistency of applied microseal 110 thickness contributes to defining a range for the total engaged thickness h′. From this, it is preferable to design the MBS 115 such that the effective modulus E_{eff} is robust against the full range of aspect ratios η that result from the preferred manufacturing and assembly processes. In this way, the present inventors have determined that a preferred way to reduce the sensitivity of the effective modulus E_{eff} to misalignment is to reduce the aforementioned spatial constraints on the microseal 110. More particularly, the present inventors have determined that there are several ways (via so-called “design knobs”) to achieve this, as discussed in more detail as follows.

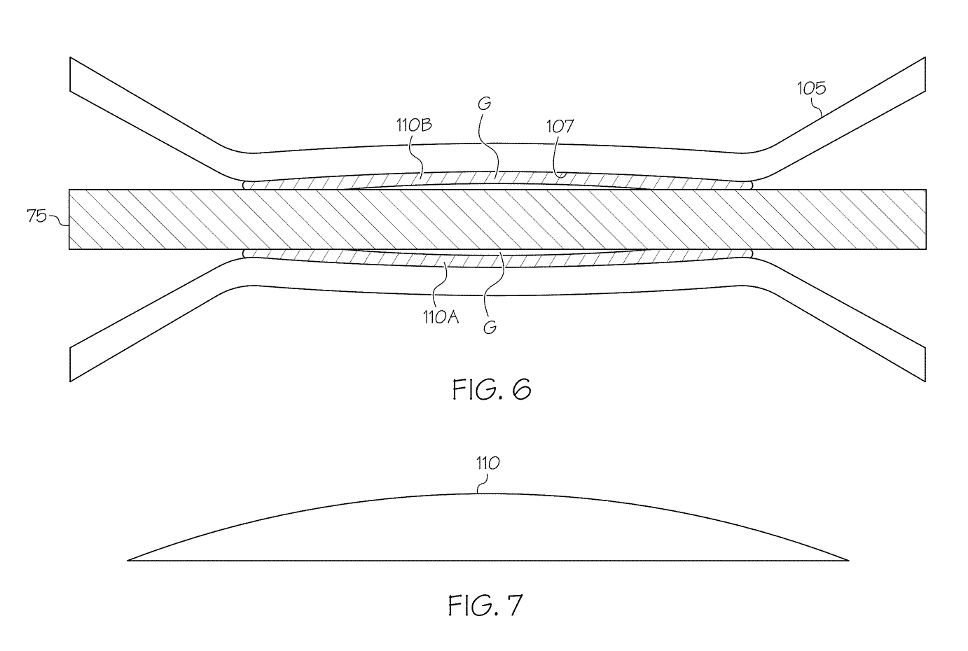

The first approach is to increase the aspect ratio η in the designed geometry, such as by (a) increasing the entire microseal 110 height, (b) utilizing a more dome-like microseal 110 profile (such as that depicted in FIG. 7) where the height h would decrease along with the width a upon misalignment and thereby reduce the relevant range of the aspect ratio η, or (c) employing an asymmetric seal design such as depicted in FIG. 4B where one microseal 110A in the repeating unit is consistently narrower than the adjacent microseal 110B, thereby enabling the engaged width a′ to remain substantially constant with misalignment α. The significance of manipulating any or all of the three spatial constraints may be seen in Table 1 that uses a nominal condition as a benchmark to show the relative sensitivity of the effective modulus E_{eff} to misalignment for different designed geometries (where each of the applied pressures have been normalized rather than shown in absolute values).

TABLE 1

| | | | E_{eff} |
|---|---|---|---|
| MISALIGNMENT, | E_{eff} (MPa) | E_{eff} (MPa) Increased | (MPa) Varying |
| α (μm) | Prior Art | Aspect Ratio | Aspect Ratio |
| 0 | 173 | 11.97 | 8.65 |
| 200 | 141 | 8.15 | 8.65 |
| 400 | 97 | 5.10 | 5.10 |

In the table, the relative effective modulus E_{eff} sensitivity to misalignment for different designed geometries is shown, where the column entitled Increased Aspect Ratio corresponds to the configuration depicted in FIG. 4A, while the column entitled Varying Aspect Ratio corresponds to the configuration depicted in FIG. 4B where a constant aspect ratio η until a misalignment threshold that equals the width of narrower microseal of the asymmetric design is attained. Thus, while the effective modulus E_{eff} and related stiffness of a seal is higher for the nominal condition (due at least in part to the high spatial constraint) than either of the relatively high aspect ratio microseal 110 design of FIG. 4A or the asymmetric microseal 110 design of FIG. 4B, it experiences a much more precipitous (and undesirable) drop with misalignment in than in either of these two designs of the present invention. As can be seen, the conventional seal configuration of the column entitled Prior Art shows a much more precipitous drop in E_{eff} with misalignment than that of the two variants of the present invention.

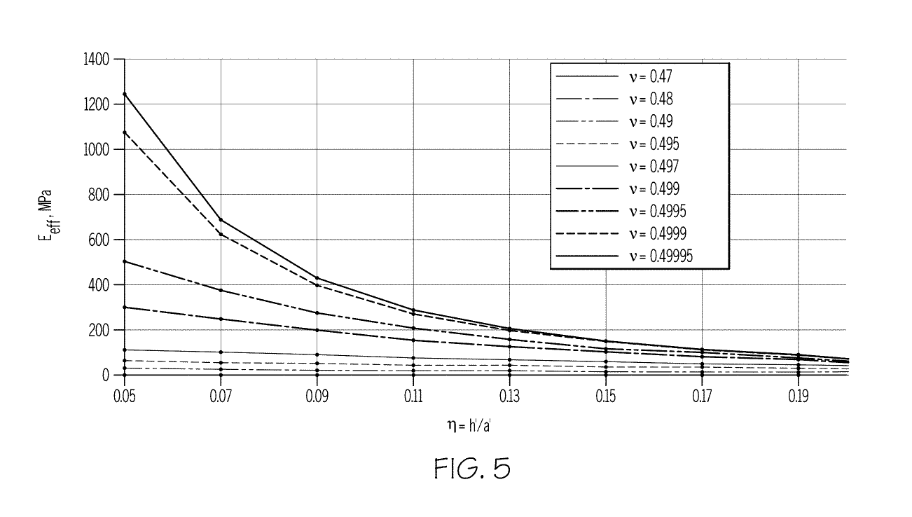

Referring next to FIG. 5, the second approach is to reduce the Poisson's Ratio v of microseal 110. This has the effect of reducing the spatial constraint on the microseal 110 by allowing material stresses to be relieved internally through the material's compressibility. In elastomers, some ways to affect the Poisson's Ratio v for a given rubber polymer backbone is to introduce foaming—either open or closed-cell—or to disperse a fraction of compressible filler throughout the material. As illustrated in FIG. 5, even small reductions in the Poisson's Ratio v from larger values (such as 0.49995 as 0.49990) to lower values (such as 0.47 to 0.497) can greatly affect the material's sensitivity to misalignment as evidenced by the formula above for the effective modulus E_{eff}.

The third approach is to reduce the adhesion or friction of the microseal 110 to the facing substrates of the subgasket 75 or the metal bead 105. Under compression, reduced friction or adhesion would allow the microseal 110 to expand laterally and escape the previously assumed spatial constraints. Nevertheless, caution must be exercised, as the addition of a lubricant as one way to lower friction or adhesion may introduce contaminants to the bipolar plate 65. Likewise, reducing the roughness of either the metal bead 105 or subgasket 75 may add a prohibitively expensive step to the substrate manufacturing, while removing microseal 110 adhesion entirely would make part handling difficult during stack 1 alignment and assembly, as well as during any needed rebuilding or reworking. With these concerns in mind, the present inventors have found that by judicious use of subgasket 75 materials, subgasket 75 reductions in surface roughness and the use of a lubricant between any or all of the interfacial regions between subgasket 75, metal bead 105 and microseal 110, may permit the relaxation of other design parameters in order to lower the pressure differential (Δp) that occurs as a result of misalignment, even in configurations where the initial pressure may be lower.

Referring next to FIGS. 6 and 7, it is advantageous to achieve continuous contact between the microseal 110, subgasket 75, and metal bead 105, as discontinuous contact across the width of the microseal 110 would otherwise arise if its thickness were not sufficient to fill the gap between the subgasket 75 and the metal bead 105. While such a scenario would be tolerable when seal alignment is perfect and the contact patches perfectly line up with each other and generate sufficient pressure to create a continuous seal along the entire length of the sealing path, the vagaries of known cell 30 alignment and stack 1 assembly mean that misalignment and numerous gaps (and concomitant leakage) will be present, especially in the region around the bends and curves. The present inventors have determined that the dome-shaped (i.e., convex) microseal 110 of FIG. 7 discussed above in conjunction with the first adjustable design knob of increasing the aspect ratio η in the microseal 110 geometry is a natural byproduct of most elastomer deposition processes, and as such is well-suited to maintaining contact throughout the expected compression range associated with stack 1 formation. This serendipitous use of the microseal 110 helps to better distribute contact pressure over the substantial entirety of the width of the engaging surface 107, which further improves one or more of the effective parameters discussed above. FIG. 6 shows this natural gap that is formed at the crown of the engaging surface 107 of the metal bead 105 that can be remedied by the screen-printed microseal 110 of FIG. 7. In the notional embodiment shown, a portion of the overall height defines a generally rectangular profile, while another portion can be used to fill the gap G of FIG. 6. Although FIG. 6 shows a gap G formation between the metal bead 105 and the subgasket 75, it will be appreciated that such a gap G may also form in configurations where no subgasket 75 is present; such a configuration may include adjacently-facing metal bead seals 105 placed directly against one another so that the space formed between corresponding engaging surfaces 107, as is also deemed to be a situation that can be remedied by the present invention.

In a preferred form, microseal 110 may be made from various resilient plastic or elastomeric materials, including polyacrylate, alhydrated chlorosulphonated polyethylene, ethylene acrylic, chloroprene, chlorosulphonated polyethylene, ethylene propylene, ethylene vinyl acetate, perfluoroelastomer, fluorocarbon, fluorosilicone, hydrogenated nitrile, polyisoprene, microcellular polyurethane, nitrile rubber, natural rubber, polyurethane, styrene-butadiene rubber, TFE/propylene, silicone, carboxylated nitrile or the like), and is preferably applied by a screen printing process known in the art, although other approaches, such as pad printing, injection molding or other deposition techniques may also be used.

It is noted that terms like “preferably”, “generally” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention, it is noted that the terms “substantially” and “approximately” and their variants are utilized herein to represent the inherent degree of uncertainty that may be attributed to any quantitative comparison, value, measurement or other representation. The term “substantially” is also utilized herein to represent the degree by which a quantitative representation may vary from a stated reference without resulting in a change in the basic function of the subject matter at issue.

Having described the invention in detail and by reference to specific embodiments, it will nonetheless be apparent that modifications and variations are possible without departing from the scope of the invention defined in the appended claims. In particular it is contemplated that the scope of the present invention is not necessarily limited to stated preferred aspects and exemplified embodiments, but should be governed by the appended claims.

We claim:

1. A bipolar plate assembly comprising:
a first plate including a metal bead projecting from at least one surface thereof, the metal bead being integrally formed from the first plate, the metal bead defining an engaging surface thereon;
a second plate including a metal bead projecting from at least one surface thereof, the metal bead being integrally formed form the first plate;
a microseal disposed on the engaging surface of the metal bead of the first plate;
a membrane electrode assembly disposed between the first plate and the second plate; and
a subgasket disposed between the first plate and the second plate, the subgasket contacting the microseal, the subgasket extending peripherally around the membrane electrode assembly to provide substantial (a) electrical isolation between an anode and a cathode formed in the membrane electrode assembly and (b) fluid isolation between the first plate and the second plate.

2. The assembly of claim 1, wherein at least one design parameter associated with the microseal defines a spatial constraint imposed on the microseal by at least one of the first plate and the second plate, the at least one design parameter being selected from the group consisting of (a) Poisson's Ratio, (b) aspect ratio and (c) surface frictional or adhesive properties.

3. The assembly of claim 2, wherein the microseal defines an aspect ratio of no greater than about 0.5.

4. The assembly of claim 3, wherein the microseal defines a Poisson's ratio of between about 0.47 and 0.497.

5. The assembly of claim 2, wherein an effective stiffness is defined as:
$${E}_{eff} = \frac{\frac{F}{{a}^{′}}}{\frac{Δ}{{h}^{′}}} = \frac{S}{η} = \frac{6 E}{( 1 + ν ) {β}^{2} {η}^{2}} [ 1 - \frac{tanh β}{β} ]$$
$$where$$
$$β = \frac{3}{η} \sqrt{\frac{2 ( 1 - 2 ν )}{1 - ν}} ,$$
F defines the amount of applied force to the microseal, a′ defines an engaged width of the microseal, h′ defines an engaged height of the microseal, and η equals the aspect ratio of the microseal, and wherein a′ is defined as a′=a−α where a defines the nominal microseal width and α defines an amount of misalignment of the microseal.

6. The assembly of claim 1, wherein the material making up the microseal is selected from the group consisting of polyacrylate, alhydrated chlorosulphonated polyethylene, ethylene acrylic, chloroprene, chlorosulphonated polyethylene, ethylene propylene, ethylene vinyl acetate, perfluoroelastomer, fluorocarbon, fluorosilicone, hydrogenated nitrile, polyisoprene, microcellular polyurethane, nitrile rubber, natural rubber, polyurethane, styrene-butadiene rubber, TFE/propylene, silicone and carboxylated nitrile.

7. The assembly of claim 1, wherein the microseal defines a first geometric profile and a second microseal disposed on the second bipolar plate defines a second geometric profile, the first geometric profile and the second geometric profile defining an asymmetric geometric profile.

8. The assembly of claim 1, wherein the microseal defines a thickness of no more than about 300 μm.

9. The assembly of claim 7, wherein the first geometric profile has a first aspect ratio and the second geometric profile has a second aspect ratio, the first aspect ratio being different than the second aspect ratio.

10. The assembly of claim 1, wherein the microseal is disposed directly on only one of the metal bead and the subgasket.

11. A method comprising:
aligning a plurality of fuel cells along a stacking axis, each of the fuel cells including a bipolar plate assembly, the bipolar plate assembly including:
a first plate including a metal bead projecting from at least one surface thereof, the metal bead being integrally formed from the first plate, the metal bead defining an engaging surface thereon,
a second plate including a metal bead projecting from at least one surface thereof, the metal bead being integrally formed form the first plate,
a microseal disposed on the engaging surface of the metal bead of the first plate;
a membrane electrode assembly disposed between the first plate and the second plate, and
a subgasket disposed between the first plate and the second plate, the subgasket contacting the microseal, the subgasket extending peripherally around the membrane electrode assembly to provide substantial (a) electrical isolation between an anode and a cathode formed in the membrane electrode assembly and (b) fluid isolation between the first plate and the second plate;
applying a compressive force along the stacking axis to the aligned fuel cells; and
securing the aligned fuel cells within a housing while maintaining the compressive force.

12. The method of claim 11, wherein at least one design parameter associated with the microseal defines a spatial constraint imposed on the microseal by at least one of the first plate and the second plate during the compressive force, the at least one design parameter being selected from the group consisting of (a) Poisson's ratio, (b) aspect ratio and (c) surface frictional or adhesive properties.

13. The method of claim 10, wherein an amount of the compressive force is based on an effective stiffness that is defined as:
$${E}_{eff} = \frac{\frac{F}{{a}^{′}}}{\frac{Δ}{{h}^{′}}} = \frac{S}{η} = \frac{6 E}{( 1 + ν ) {β}^{2} {η}^{2}} [ 1 - \frac{tanh β}{β} ]$$
$$where$$
$$β = \frac{3}{η} \sqrt{\frac{2 ( 1 - 2 ν )}{1 - ν}} ,$$
F defines the amount of applied force to the microseal, a′ defines an engaged width of the microseal, h′ defines an engaged height of the microseal, and η equals the aspect ratio of the microseal, and wherein a′ is defined as a′=a−α where a defines the nominal microseal width and α defines an amount of misalignment of the microseal.

14. The method of claim 12, wherein the Poisson's ratio is adjusted through parametric changes in at least one of (a) material selection for the microseal, (b) filler material added to a precursor to the microseal, and (c) cell-formation within the microseal.

15. The method of claim 12, wherein the aspect ratio is adjusted through parametric changes in at least one of (a) a dome profile formed by the microseal, (b) thickness adjustments to the microseal, and (c) variations in width between adjacent pairs of the microseals.

16. The method of claim 12, wherein adjustment to the surface frictional or adhesive properties is achieved through parametric changes in at least one of (a) material selection for the subgasket, (b) surface roughness formed on the subgasket, and (c) application of a lubricant between the subgasket and the microseal.

17. The method of claim 11, wherein the material making up the microseal is selected from the group consisting of polyacrylate, alhydrated chlorosulphonated polyethylene, ethylene acrylic, chloroprene, chlorosulphonated polyethylene, ethylene propylene, ethylene vinyl acetate, perfluoroelastomer, fluorocarbon, fluorosilicone, hydrogenated nitrile, polyisoprene, microcellular polyurethane, nitrile rubber, natural rubber, polyurethane, styrene-butadiene rubber, TFE/propylene, silicone and carboxylated nitrile.

18. The method of claim 11, wherein the microseal defines a first geometric profile and a second microseal disposed on the second bipolar plate defines a second geometric profile, the first geometric profile and the second geometric profile defining an asymmetric geometric profile.

19. The method of claim 18, wherein the first geometric profile has a first aspect ratio and the second geometric profile has a second aspect ratio, the first aspect ratio being different than the second aspect ratio.

20. The method of claim 11, wherein the microseal is disposed by a screen printing process.
